(19) United States
(12) Patent Application Publication
(10) Pub. No.: US 2016/0202957 A1
(43) Pub. Date: Jul. 14, 2016

(54) REACTIVE AGENT DEVELOPMENT ENVIRONMENT

(71) Applicant: Microsoft Technology Licensing, LLC, Redmond, WA (US)

(72) Inventors: Zachary Thomas John Siddall, Bellevue, WA (US); Vishwac Sena Kannan, Redmond, WA (US); Aleksandar Uzelac, Seattle, WA (US); Eric Christian Brown, Seattle, WA (US); Daniel J. Hwang, Renton, WA (US)

(73) Assignee: Microsoft Technology Licensing, LLC, Redmond, WA (US)

(21) Appl. No.: 14/596,048

(22) Filed: Jan. 13, 2015

(51) Int. Cl. G06F 9/44; G06F 17/30; G06F 17/24

(52) U.S. Cl. CPC G06F 8/34; G06F 17/248; G06F 17/30923

(57) ABSTRACT

A method for generating a reactive agent definition may include acquiring, by a reactive agent development environment (RADE) tool of a computing device, an extensible markup language (XML) schema template for defining a reactive agent of a digital personal assistant running on the computing device. The RADE tool may receive input identifying at least one domain-intent pair associated with a category of functions performed by the computing device. A multi-turn dialog flow defining a plurality of states associated with the domain-intent pair may be generated using a graphical user interface of the RADE tool. The XML schema template may be updated based on the received input and the multi-turn dialog flow to produce an updated XML schema specific to the domain-intent pair. The reactive agent definition may be generated using the updated XML schema.

### BACKGROUND

As computing technology has advanced, increasingly powerful mobile devices have become available. For example, smart phones and other computing devices have become commonplace. The processing capabilities of such devices have resulted in different types of functionalities being developed, such as functionalities related to digital personal assistants.

A digital personal assistant can be used to perform tasks or services for an individual. For example, the digital personal assistant can be a software module running on a mobile device or a desktop computer. Additionally, a digital personal assistant implemented within a mobile device has interactive and built-in conversational understanding to be able to respond to user questions or speech commands. Examples of tasks and services that can be performed by the digital personal assistant can include making phone calls, sending an email or a text message, and setting calendar reminders.

While a digital personal assistant may be implemented to perform multiple tasks using reactive agents, programming/defining each reactive agent may be time consuming Therefore, there exists ample opportunity for improvement in technologies related to creating and editing reactive agent definitions for implementing a digital personal assistant.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, a computing device that includes a processing unit, memory coupled to the processing unit, one or more microphones, one or more speakers, and at least one display, may be configured with a reactive agent development environment (RADE) to perform operations for generating a reactive agent definition. The RADE may include a visual editing tool (e.g., the visual tool illustrated in FIGS. 2A-2E, herein referred to as RADE tool) or an alternate development environment. The operations may include acquiring an extensible markup language (XML) schema template. The XML schema template may contain a plurality of XML code segments for defining a reactive agent of a digital personal assistant running on the computing device. The RADE tool may receive input identifying a domain and at least one intent for the domain. The domain may be associated with a category of functions performed by the computing device. The at least one intent may be associated with at least one action used to perform at least one function of the category of functions for the identified domain. A multi-turn dialog flow defining a plurality of states for the at least one intent may be generated using a graphical user interface of the RADE tool. Alternatively, a single-turn dialog flow defining one or more states for the at least one intent may also be generated using the RADE tool. The XML schema template may be updated using the RADE tool, based on the received input and the multi-turn dialog flow, to produce an updated XML schema specific to the identified domain and the at least one intent. Programming code causing the computing device to perform the at least one action may be provided and combined with the updated XML schema to generate the reactive agent definition.

In accordance with one or more aspects, a method for generating a reactive agent definition may include acquiring, by a reactive agent development environment (RADE) tool of a computing device, an extensible markup language (XML) schema template for defining a reactive agent of a digital personal assistant running on the computing device. The RADE tool may receive input identifying at least one domain-intent pair associated with a category of functions performed by the computing device. A multi-turn dialog flow defining a plurality of states associated with the domain-intent pair may be generated using a graphical user interface of the RADE tool. The XML schema template may be updated based on the received input and the multi-turn dialog flow to produce an updated XML schema specific to the domain-intent pair. The reactive agent definition may be generated using the updated XML schema.

In accordance with one or more aspects, a computer-readable storage medium may include instructions that upon execution cause a computing device to perform operations for generating a reactive agent definition of a digital personal assistant running on the computing device. The operations may include receiving using a reactive agent definition editing (RADE) tool of the computing device, input identifying a domain, at least one intent for the domain, and at least one slot for the at least one intent. The domain is associated with a category of functions performed by the computing device. The at least one intent is associated with at least one action used to perform at least one function of the category of functions for the identified domain. The at least one slot is associated with a value used to initiate performing the at least one action. For each of the at least one intent, a multi-turn dialog flow defining a plurality of states associated with the at least one intent, may be generated using a graphical user interface of the RADE tool. An extensible markup language (XML) schema template may be updated using the RADE tool with at least one XML code section. The updating can be based on the received input and the multi-turn dialog flow, to produce an updated XML schema specific to the identified domain, the at least one intent and the at least one slot. Programming code causing the computing device to perform the at least one action may be generated. The updated XML schema and the programming code may be combined to generate the reactive agent definition.

As described herein, a variety of other features and advantages can be incorporated into the technologies as desired.

### BRIEF DESCRIPTION OF THE DRAWINGS

FIG. 1 is a block diagram illustrating an example software architecture for a reactive agent development environment (RADE), in accordance with an example embodiment of the disclosure.

FIGS. 2A-2E illustrate example user interface of a RADE tool, which may be used to generate a reactive agent definition file, in accordance with an example embodiment of the disclosure.

FIGS. 3A-3B illustrate an example XML schema template, which may be used for generating a reactive agent definition, in accordance with an example embodiment of the disclosure.

FIGS. 4A-4H illustrate an example XML schema used in a reactive agent definition, in accordance with an example embodiment of the disclosure.

FIGS. 5-7 are flow diagrams illustrating generating of a reactive agent definition, in accordance with one or more embodiments.

FIG. 8 is a block diagram illustrating an example mobile computing device in conjunction with which innovations described herein may be implemented.

FIG. 9 is a diagram of an example computing system, in which some described embodiments can be implemented.

FIG. 10 is an example cloud computing environment that can be used in conjunction with the technologies described herein.

### DETAILED DESCRIPTION

As described herein, various techniques and solutions can be applied for generating reactive agent definitions using a reactive agent development environment (RADE). More specifically, the RADE may be implemented (e.g., as a visual editing tool (RADE tool) or as another alternate development environment) on a computing device (e.g., as software running on the computing device) and may use one or more graphical user interfaces for building an explicit representation of a multi-turn dialog flow, including representations of a domain, one or more intents associated with the domain, one or more slots for a domain-intent pair, one or more states for an intent, transitions between states, response templates, and so forth. The domain, intent and slot information may be provided to the RADE as input. After the multi-turn dialog flow for performing the desired agent functionalities is complete, the RADE may update an XML schema template (or another type of a computer-readable document) using the information provided to (or entered via) the RADE tool, such as domain information, intent information, slot information, state information, state transitions, response strings and templates, localization information and any other information entered via the RADE to provide the visual/declarative representation of the reactive agent functionalities. Additionally, XML code segments within the XML schema template may be annotated so that an XML portion of the reactive agent definition may be easily interpreted by a user (e.g., a programmer), with each XML code section type indicated in the XML code listing.

In this document, various methods, processes and procedures are detailed. Although particular steps may be described in a certain sequence, such sequence is mainly for convenience and clarity. A particular step may be repeated more than once, may occur before or after other steps (even if those steps are otherwise described in another sequence), and may occur in parallel with other steps. A second step is required to follow a first step only when the first step must be completed before the second step is begun. Such a situation will be specifically pointed out when not clear from the context. A particular step may be omitted; a particular step is required only when its omission would materially impact another step.

In this document, the terms “and”, “or” and “and/or” are used. Such terms are to be read as having the same meaning; that is, inclusively. For example, “A and B” may mean at least the following: “both A and B”, “only A”, “only B”, “at least both A and B”. As another example, “A or B” may mean at least the following: “only A”, “only B”, “both A and B”, “at least both A and B”. When an exclusive-or is intended, such will be specifically noted (e.g., “either A or B”, “at most one of A and B”).

In this document, various computer-implemented methods, processes and procedures are described. It is to be understood that the various actions (receiving, storing, sending, communicating, displaying, etc.) are performed by a hardware device, even if the action may be authorized, initiated or triggered by a user, or even if the hardware device is controlled by a computer program, software, firmware, etc. Further, it is to be understood that the hardware device is operating on data, even if the data may represent concepts or real-world objects, thus the explicit labeling as “data” as such is omitted. For example, when the hardware device is described as “storing a record”, it is to be understood that the hardware device is storing data that represents the record.

As used herein, the term “reactive agent” refers to a data/command structure which may be used by a digital personal assistant to implement one or more response dialogs (e.g., voice, text and/or tactile responses) associated with a device functionality. The device functionality (e.g., emailing, messaging, etc.) may be activated by a user input (e.g., voice command) to the digital personal assistant. The reactive agent (or agent) can be defined using a voice agent definition (VAD) or a reactive agent definition (RAD) XML document (or another type of a computer-readable document) as well as programming code (e.g., C++ code) used to drive the agent through the dialog. For example, an email reactive agent may be used to, based on user voice command, open a new email window, compose an email based on voice input, and send the email to an email address specified a voice input to a digital personal assistant. A reactive agent may also be used to provide one or more responses (e.g., audio/video/tactile responses) during a dialog session initiated with a digital personal assistant based on the user input.

As used herein, the term “XML schema” refers to a document with a collection of XML code segments that are used to describe and validate data in an XML environment. More specifically, the XML schema may list elements and attributes used to describe content in an XML document, where each element is allowed, what type of content is allowed, and so forth. A user may generate an XML file (e.g., for use in a reactive agent definition), which adheres to the XML schema.

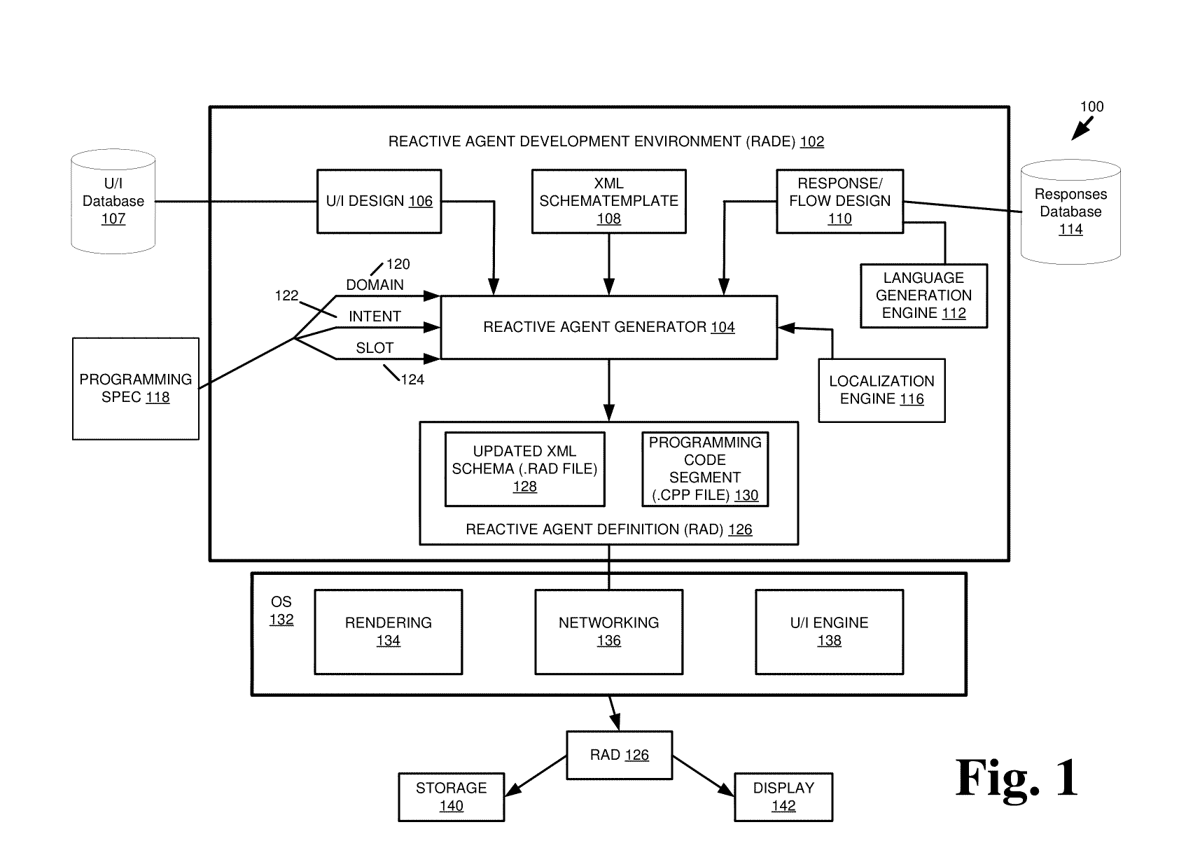

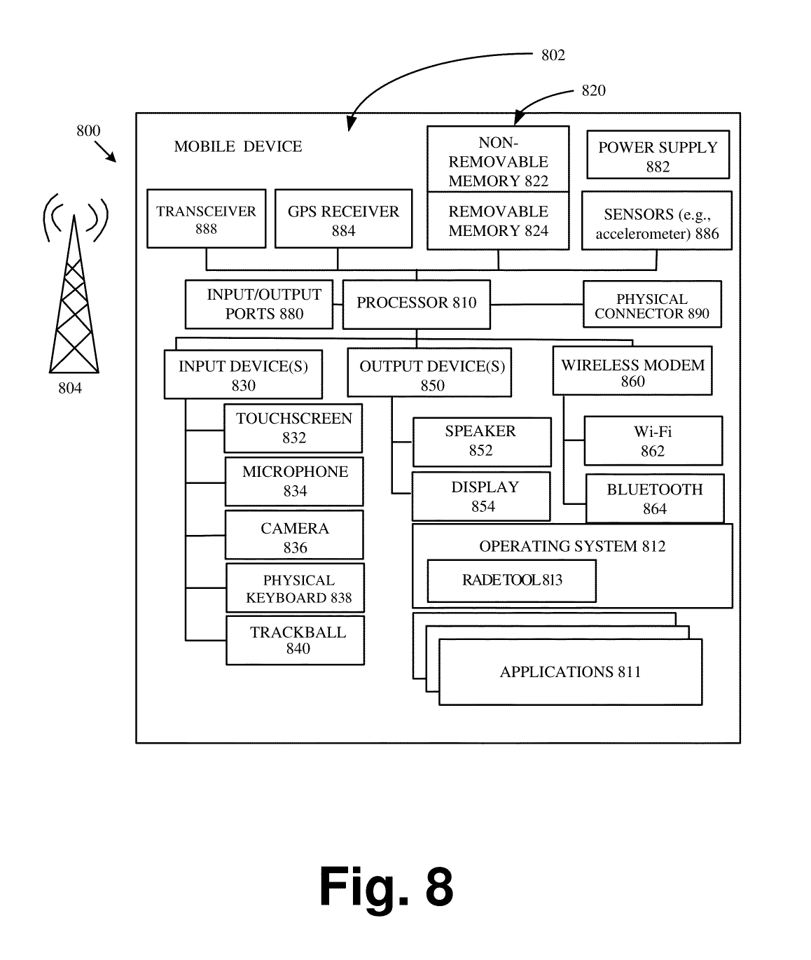

FIG. 1 is a block diagram illustrating an example software architecture 100 for a reactive agent development environment (RADE), in accordance with an example embodiment of the disclosure. Referring to FIG. 1, a client computing device (e.g., smart phone or other mobile computing device such as device 800 in FIG. 8) can execute software organized according to the architecture 100 to provide generation and editing of reactive agent definitions.

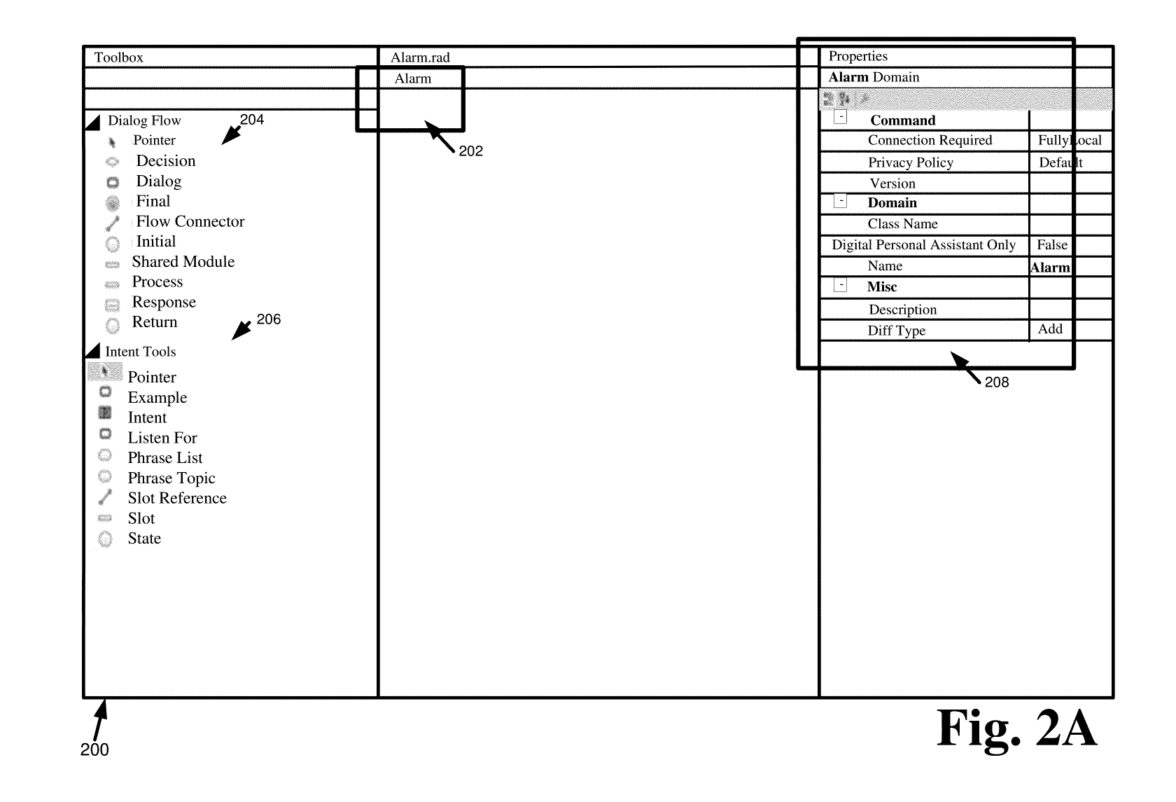

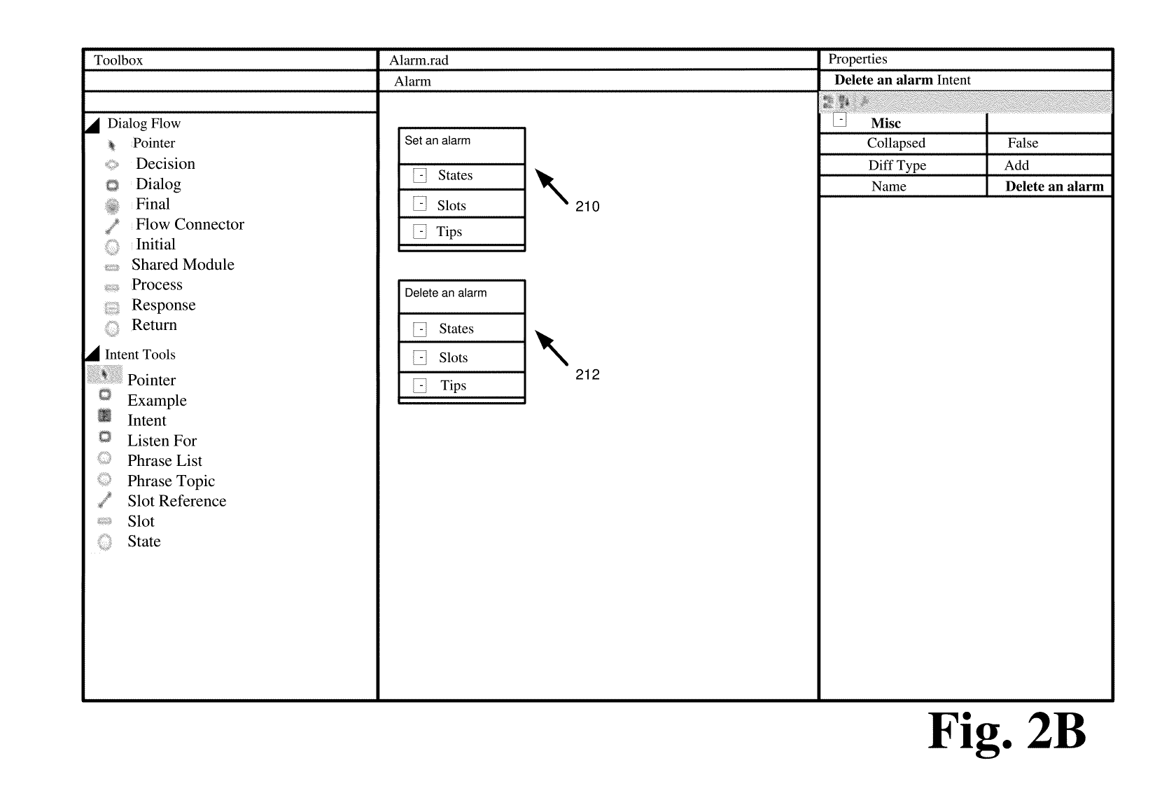

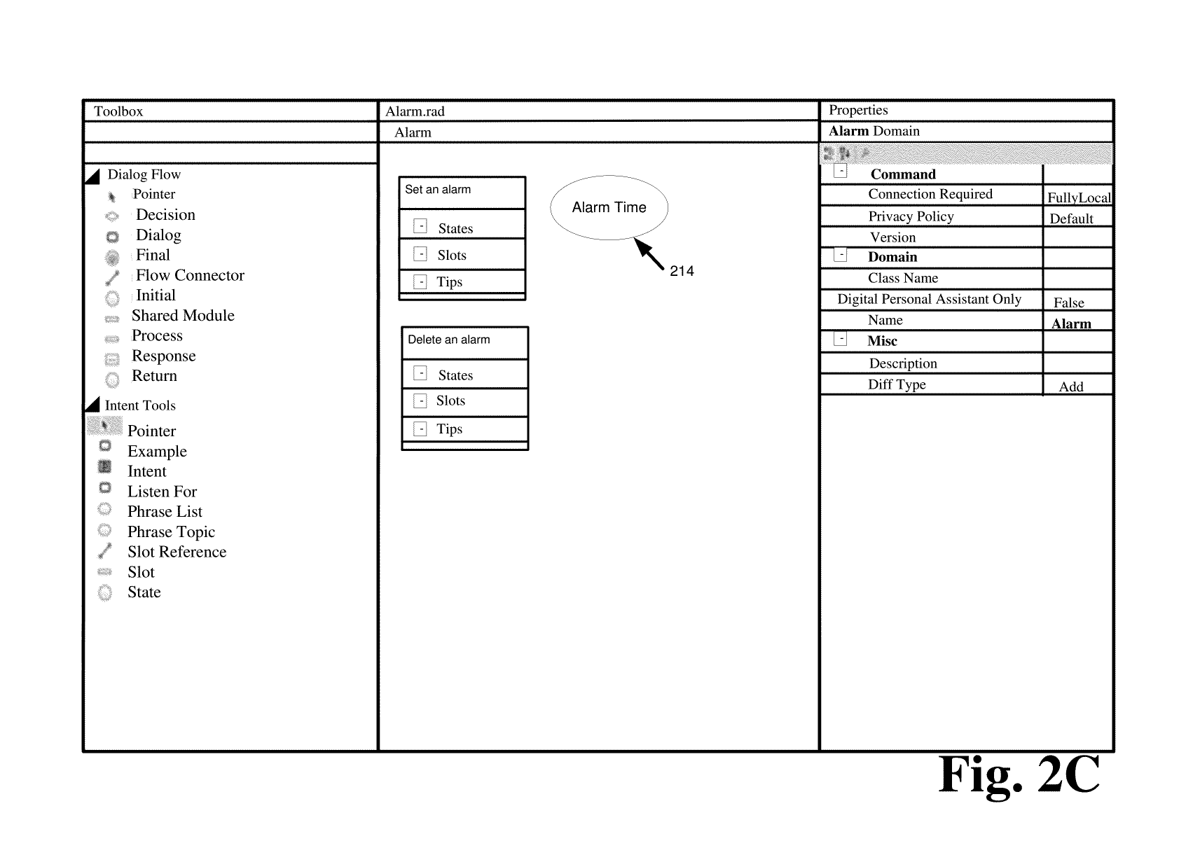

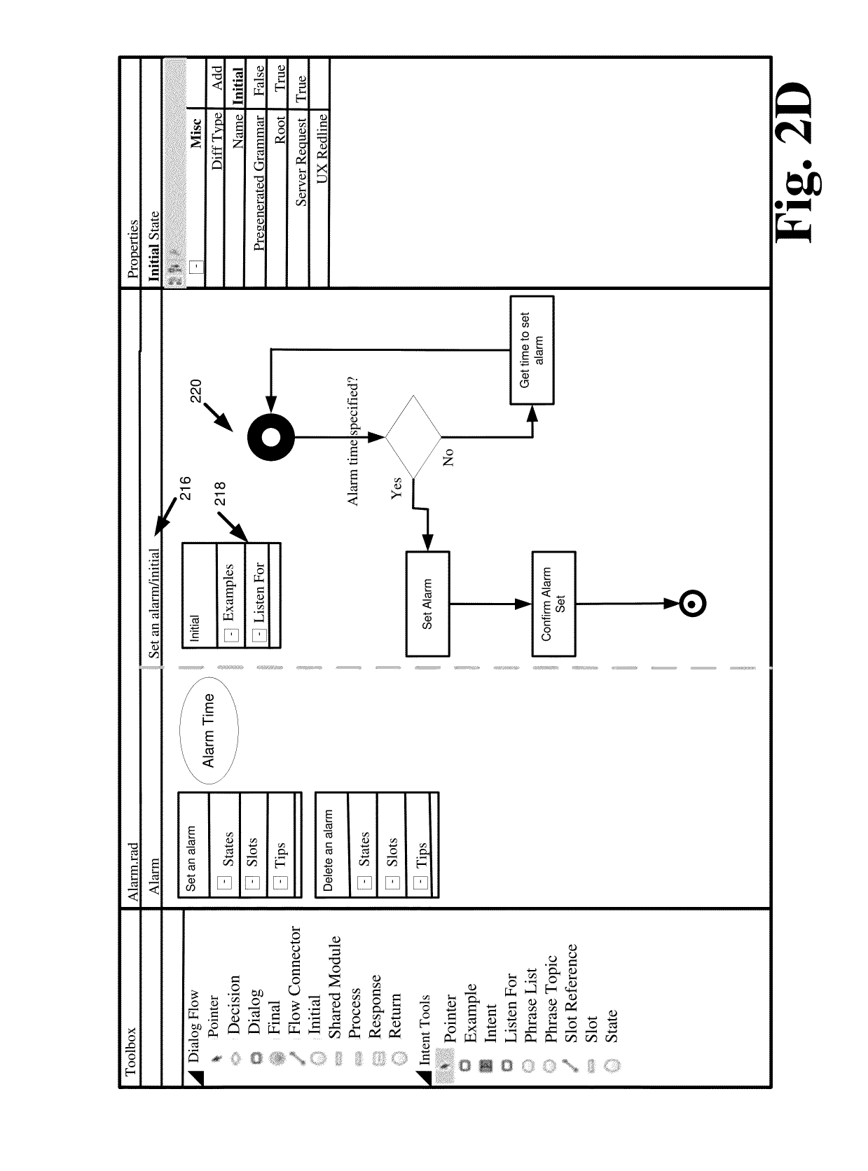

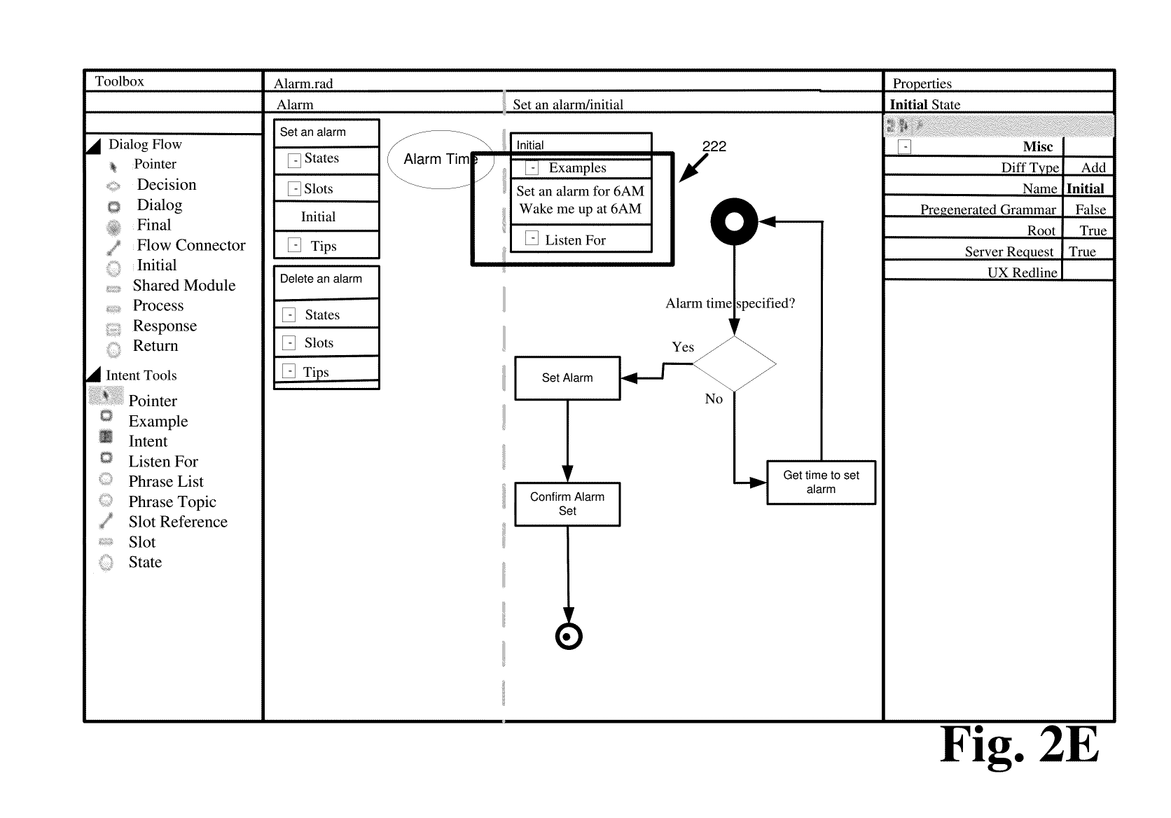

The architecture 100 includes a device operating system (OS) 132 and a reactive agent development environment (RADE) 102. In FIG. 1, the device OS 132 includes components for rendering 134 (e.g., rendering visual output to a display, generating voice output for a speaker, and so forth), components for networking 136, and a user interface (U/I) engine 138. The U/I engine 138 may be used to generate one or more graphical user interfaces (e.g., as illustrated in FIGS. 2A-2E) in connection with reactive agent definition editing functionalities performed by the RADE 102. The user interfaces may be rendered on display 142, using the rendering component 134. Input received via a user interface generated by the U/I engine 138 may be communicated to the reactive agent generator 104. The device OS 132 manages user input functions, output functions, storage access functions, network communication functions, and other functions for the device 800. The device OS 132 provides access to such functions to the RADE 102.

The RADE 102 may comprise suitable logic, circuitry, interfaces, and/or code and may be operable to provide functionalities associated with reactive agent definitions (including generating and editing such definitions), as explained herein. The RADE 102 may comprise a reactive agent generator 104, U/I design block 106, an XML schema template block 108, response/flow design block 110, language generation engine 112, and a localization engine 116. The reactive agent development environment 102 may include a visual editing tool (e.g., as illustrated in FIGS. 2A-2E) or an alternate development environment for generating and editing reactive agents. In this regard, any reference to a RADE tool herein (e.g., RADE tool 102) may refer to the reactive agent development environment 102 when used in connection with a visual editing tool, such as the visual editing tool illustrated in FIGS. 2A-2E. However, other implementations of the RADE 102 are also possible as an alternative embodiment. For example, the tool may be an XML editor that may or may not use visual editing functionalities for performing edits on a single- or multi-turn flow. Another development environment could have a combination of different documents or views coming together to capture an agent definition. As an example, a dialog flow may be captured in a separate document (XML based or another type of computer-readable document), and then capture the responses in a separate document. The development environment could help streamline the reactive agent definition authoring experience by bringing these separate documents together.

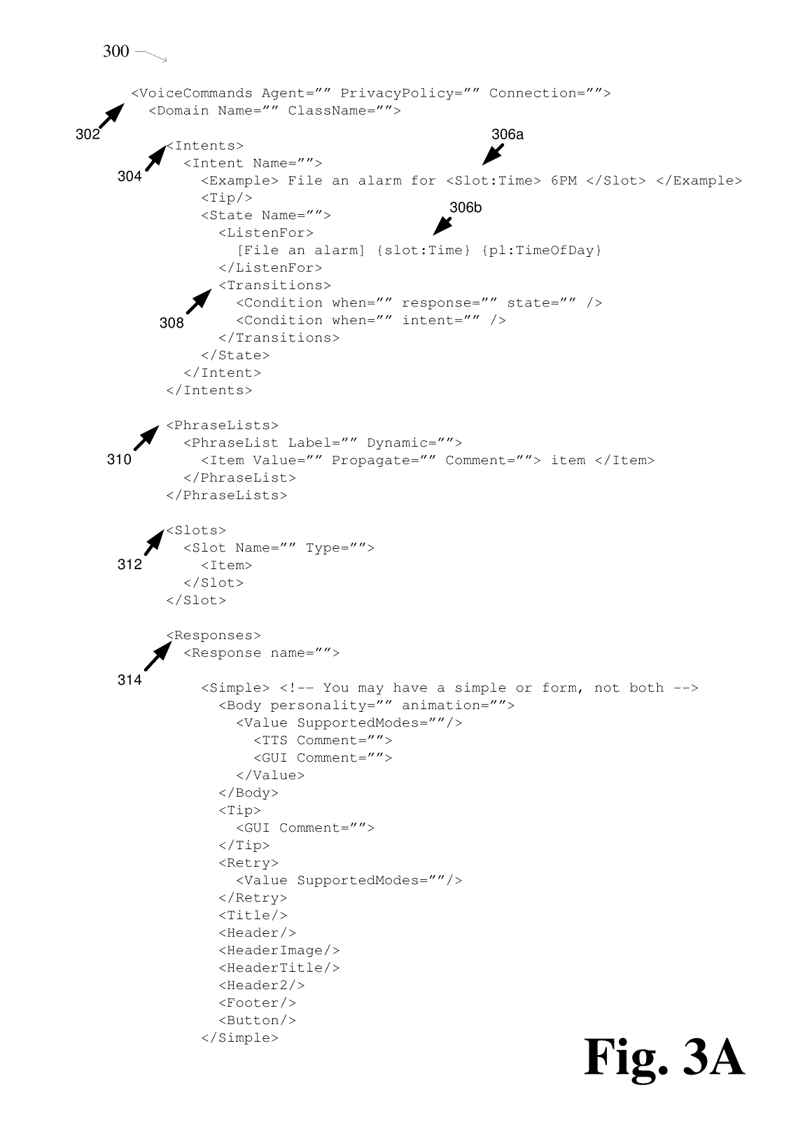

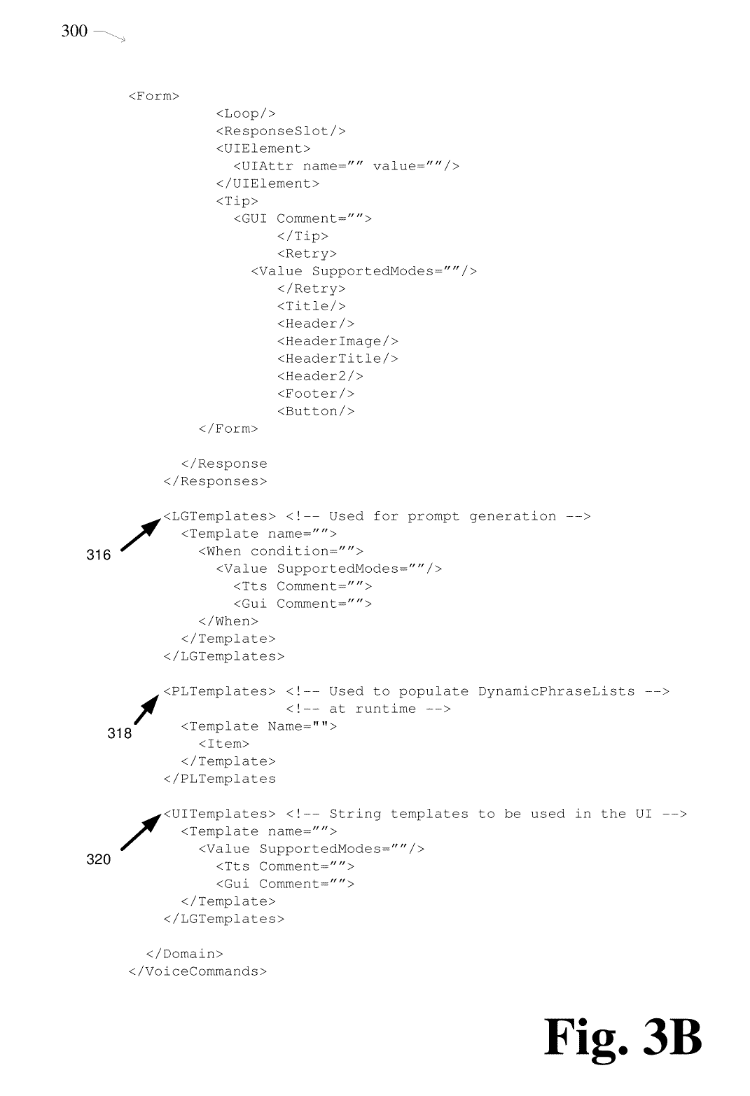

The XML schema template block 108 may be operable to provide an XML schema template, such as the template listed in FIGS. 3A-3B. FIGS. 3A-3B illustrate an example XML schema template, which may be used for generating a reactive agent definition, in accordance with an example embodiment of the disclosure. Referring to FIGS. 3A-3B, the XML schema template 300 may include a plurality of XML code sections, which may be updated (e.g., by the reactive agent generator 104) in order to create a new/updated XML schema (e.g., 128) for a reactive agent definition (e.g., 126). For example, XML code section 302 may be used to designate a domain. The term “domain” may be used to indicate a realm or range of personal knowledge and may be associated with a category of functions performed by a computing device. Example domains include email (e.g., an email reactive agent can be used by a digital personal assistant (DPA) to generate/send email), message (e.g., a message reactive agent can be used by a DPA to generate/send text messages), alarm (an alarm reactive agent can be used to set up/delete/modify alarms), and so forth.

The XML code section 304 may be used to designate one or more intents. As used herein, the term “intent” may be used to indicate at least one action used to perform at least one function of the category of functions for an identified domain. For example, “set an alarm” intent may be used for an alarm domain (as seen in FIGS. 2A-2E).

The XML code sections 306a-306b and 312 may be used to designate one or more slots associated with an intent. As used herein, the term “slot” may be used to indicate specific value or a set of values used for completing a specific action for a given domain-intent pair. A slot may be associated to one or more intents and may be explicitly provided (i.e., annotated) in the XML schema template. Typically, domain, intent and slots make a language understanding construct, however within a given agent scenario, a slot could be shared across multiple intents. As an example, if the domain is alarm with two different intents—set an alarm and delete an alarm, then both these intents could share the same “alarmTime” slot. In this regard, a slot may be connected to one or more intents.

The XML code section 308 may be used to designate one or more state transitions. One or more states may be associated with an intent and the state transitions may indicate transitions between the states based on whether or not a condition has been met. A state may denote a specific point in a dialog flow. As an example, in a dialog flow for creating an alarm (e.g., FIGS. 2A-2E), the user can start at the “initial” state and subsequently if they did not specify the time as part of their utterance (e.g. the user said “I want to set an alarm”), the dialog flow will determine that one of the required slot value “alarmTime” is missing and so will transition to “getAlarmTime” state. A state typically has some processing block (internal to an agent) or could have a response followed by a listening state or could have its own sub-dialog flow.

The XML code section 310 may be used to designate one or more phrase lists. As used herein, the term “phrase list” may be used to designate a list/collection of words or sentences that a reactive agent will be listening for at any given state. The XML code section 314 may be used to designate one or more response strings.

The XML code section 316 may be used to designate one or more language generation templates, which may be used (e.g., by the language generation engine 112) to generate prompts. For example, if a given condition is satisfied, a text-to-speech (TTS) response string and/or a GUI response string (i.e., displayed text) may be generated/selected for output.

The XML code section 318 may be used to populate dynamic phrase lists (e.g., at runtime). The XML code section 320 may be used to designate one or more user interface templates. A user interface template may include a response string (or response string template) for use in a user interface.

In accordance with an example embodiment of the disclosure, the XML code sections within the XML schema template 108 may be explicitly annotated based on the type of the enclosing XML code element. For example, some response strings may be annotated based on the intended use—some responses may be used for language generation (e.g., by the language generation engine 112), some for dialog responses, and some for U/I elements.

The U/I design module 106 may comprise suitable logic, circuitry, interfaces, and/or code and may be operable to generate and provide to the reactive agent generator 104 one or more user interfaces for use with the reactive agent definition (RAD) 126. The U/I design module 106 may acquire one or more user interface designs from the U/I database 107 or may generate a new user interface design based on input provided with the programming specification 118. In an example embodiment, the U/I design module 106 may be implemented together with the U/I engine 138, as part of the OS 132 or the RADE tool 102.

The response/flow design module 110 may comprise suitable logic, circuitry, interfaces, and/or code and may be operable to provide one or more response strings for use by the reactive agent generator. For example, response strings (and presentation modes for the response strings) may be selected from the responses database 114. The language generation engine 112 may be used to generate one or more human-readable responses, which may be used in connection with a given domain-intent-slot configuration (e.g., based on inputs 120-124 provided by the programming specification 118). The response/flow design module 110 may also provide the reactive agent generator 104 with flow design in connection with a multi-turn dialog flow (e.g., required steps for performing a certain action within a multi-turn dialog flow).

In an example implementation and for a given RAD (e.g., 126) generated by the reactive agent generator 104, the selection of the response strings and/or a presentation mode for such responses may be further based on other factors, such as a user's distance from a device, the user's posture (e.g., laying down, sitting, or standing up), knowledge of the social environment around the user (e.g., are other users present), noise level, and current user activity (e.g., user is in an active conversation or performing a physical activity). The user's distance from a device may be determined based on, for example, received signal strength when the user communicates with the device via a speakerphone. If it is determined that the user is beyond a threshold distance, the device may consider that the screen is not visible to the user and is, therefore, unavailable. In this regard, the XML schema template 108 may be updated so that the RAD 126 implements the above functionalities.

In operation, the reactive agent generator 104 may receive input from a programming specification 118. For example, the programming specification 118 may specify a domain, one or more intents and one or more slots via inputs 120, 122, and 124, respectively. The reactive agent generator (RAG) 104 may also acquire the XML schema template 108 and generate an updated XML schema 128 based on, for example, user input received via the U/I design module 106. Response/flow input from the response/flow design module 110, as well as localization input from the localization engine 116, may be used by the RAG 104 to further update the XML schema template 108 and generate the updated XML schema 128. An additional programming code segment 130 (e.g., a C++ file) may also be generated to implement and manage performing of one or more requested functions by the digital personal assistant and/or the computing device. The updated XML schema 128 and the programming code segment 130 may be combined to generate the RAD 126. The RAD 126 may then be output to a display 142 and/or stored in storage 140.

Even though the XML schema template 108 is an XML document, the present disclosure may not be limited in this regard and other types of templates may be used in lieu of XML documents. In accordance with an example embodiment of the disclosure, other types of computer-readable documents (e.g., another type of schema template 108) may be used in lieu of the XML documents discussed herein.

FIGS. 2A-2E illustrate example user interface of a RADE tool, which may be used to generate a reactive agent definition file, in accordance with an example embodiment of the disclosure. Referring to FIGS. 2A-2E, there is illustrated an example user interface 200, which may be used in connection with the RADE tool 102 to generate a reactive agent definition for an “alarm” domain. For example, at 202, an “alarm” domain may be specified. The user interface 200 may include user interface dialog flow tools 204 and intent tools 206, which may be used to further specify and define a multi-turn dialog flow for defining the reactive agent definition for an “alarm” reactive agent. Additionally, for each entered domain (e.g., 202), one or more domain properties 208 may also be entered/provided. Example domain properties include domain privacy policy, domain version, a type of connection required by the domain, and so forth.

The dialog flow tools 204 may be used to provide a flow diagram-like representation of states, transitions, and transition conditions for specifying a multi-turn dialog flow for a conversation/dialog between a human and a digital personal assistant. The dialog flow tools 204 may include the following commands:

“Decision”—represents a logical decision block;

“Dialog”—a state for a digital personal assistant, where the assistant is actively looking for a specific user input (can optionally include a response);

“Initial”, “Final”, “Return”, “Flow Connector”—starting/terminating states of a dialog flow and associated intermediate state connections (return state denotes a non-terminal transfer of flow back to the caller of a dialog state);

“Shared Module”—a state in a dialog flow that is shared across multiple intents;

“Process”—a state where the system performs an operation; and

“Response”—a state where a digital personal assistant either speaks back or displays a text in the UI or provides a feedback to the user through any available modality (e.g., audio/visual/tactile output).

The intent tools 206 may include the following commands:

“Example”—each dialog flow may have multiple examples (e.g., 222 in FIG. 2E) which can capture a set of phrases a user can say to activate the specific dialog state (e.g., if a user is trying to set an alarm, examples would be “set an alarm”, “please set an alarm”, “set an alarm for 7 am”, “wake me up at 7 am”, and so forth);

“Intent”—at least one action used to perform at least one function of the category of functions for an identified domain. For example, “set an alarm” intent 210 and delete an alarm intent 212 may be used for an alarm domain 202 (as seen in FIGS. 2A-2E).

“Slot”—specific value or a set of values used for completing a specific action for a given domain-intent pair. For example, an “alarm time” slot 214 may be specified for the “set an alarm” intent 210.

“State”—a state may denote a specific point in a dialog flow. As an example, in a dialog flow for creating an alarm (e.g., FIGS. 2A-2E), the user can start at the “initial” state (at 216-218 in FIG. 2D) and subsequently if they did not specify the time as part of their utterance (e.g. the user said “I want to set an alarm”), the dialog flow will determine that one of the required slot value “alarmTime” is missing and so will transition to “getAlarmTime” state. A state typically has some processing block (internal to an agent) or could have a response followed by a listening state or could have its own sub-dialog flow. The multi-turn dialog flow 220 may be specified using the dialog flow tools 204 and the intent tools 206. More specifically, the multi-turn dialog flow 220 may be used to designate one or more state transitions between one or more states associated with an intent (e.g., set an alarm intent 210) and the state transitions may indicate transitions between the states based on whether or not a condition has been met (e.g., whether alarm time is specified).

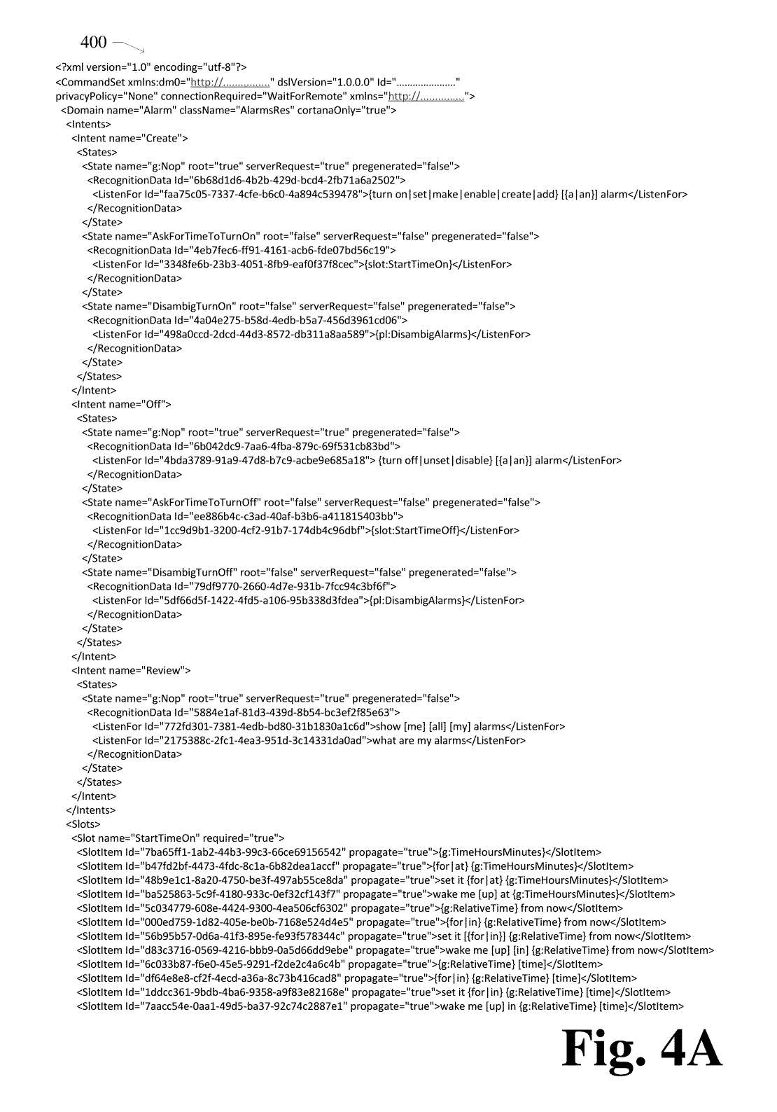

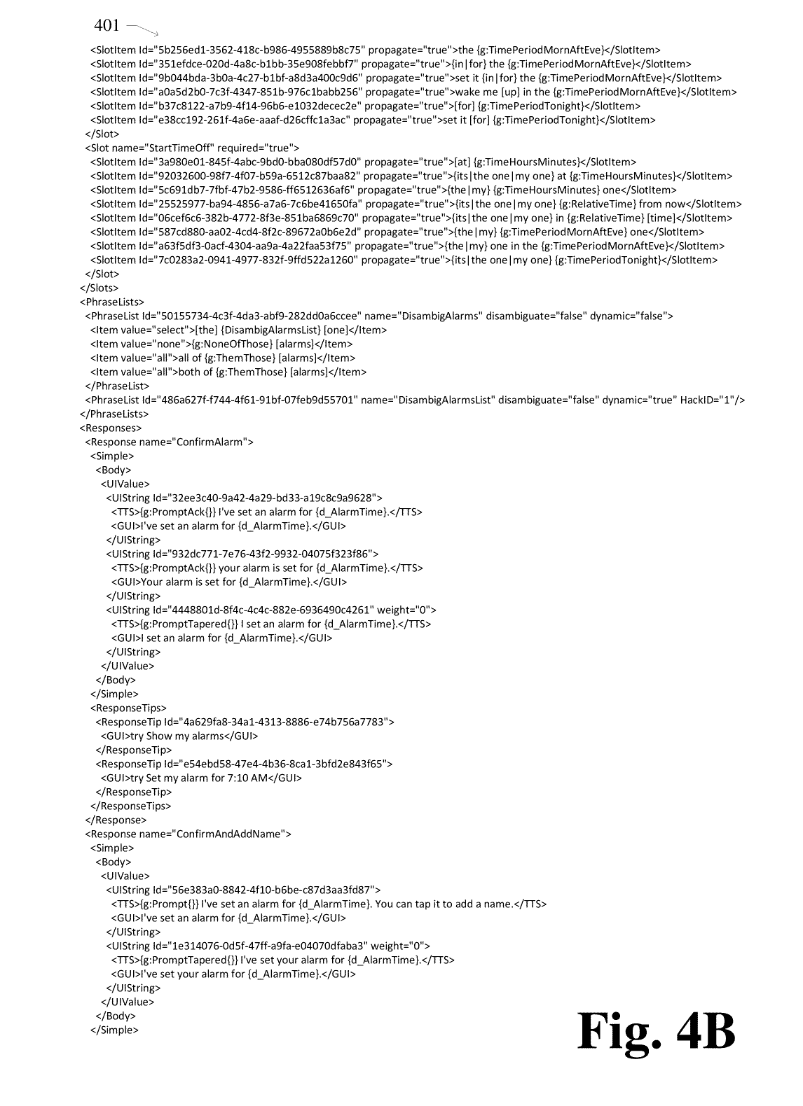

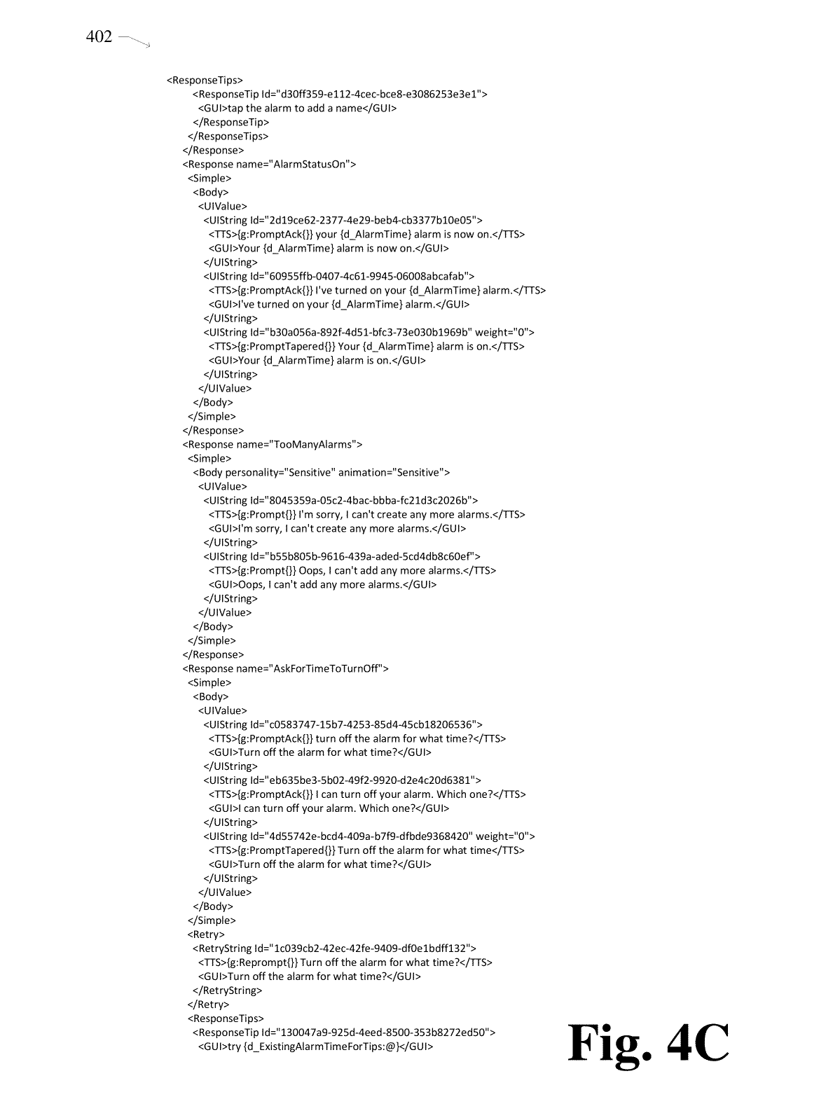

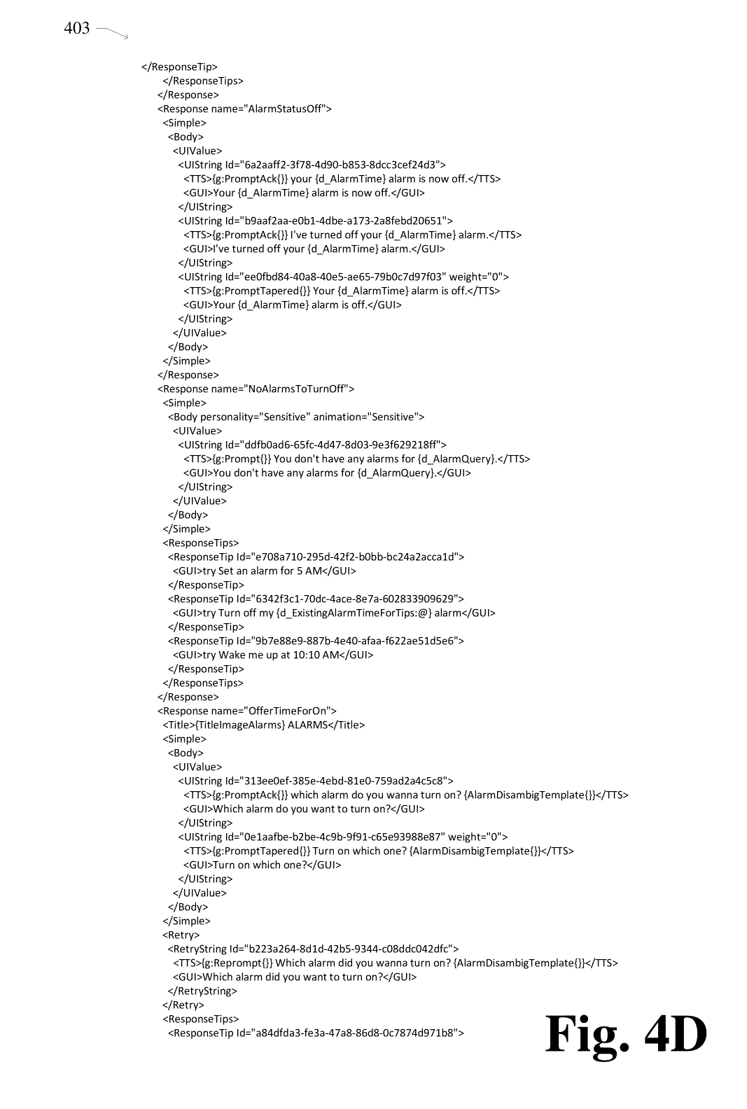

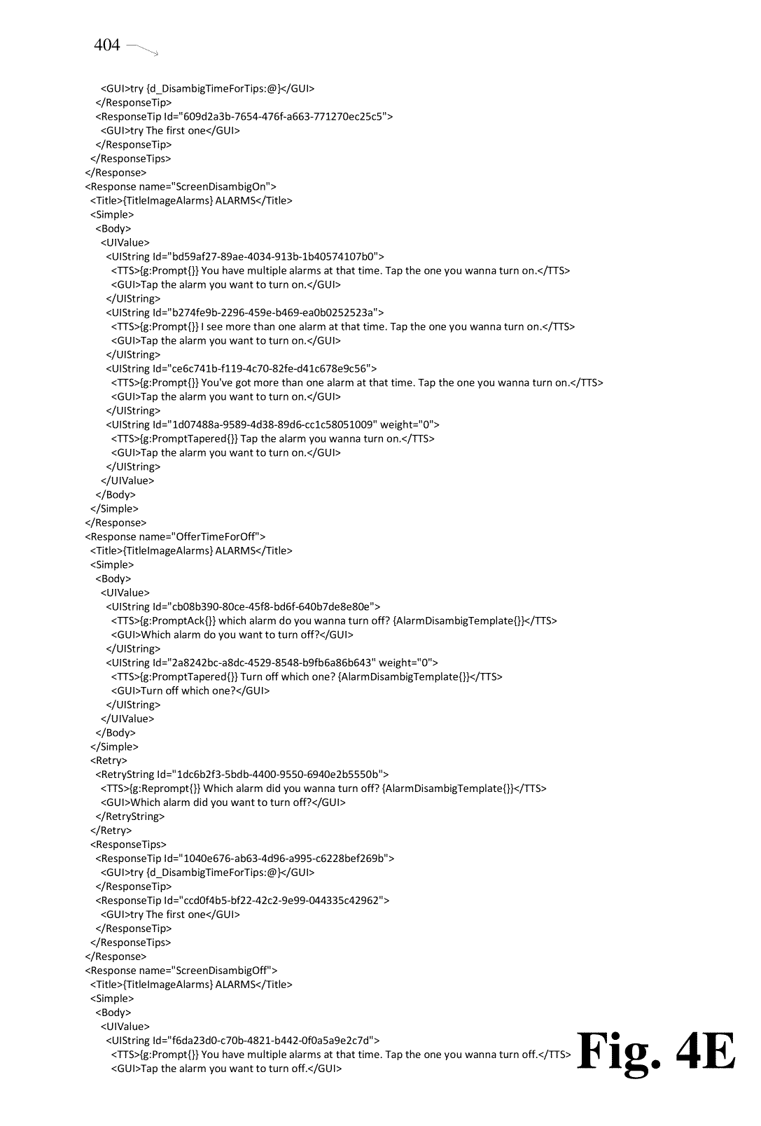

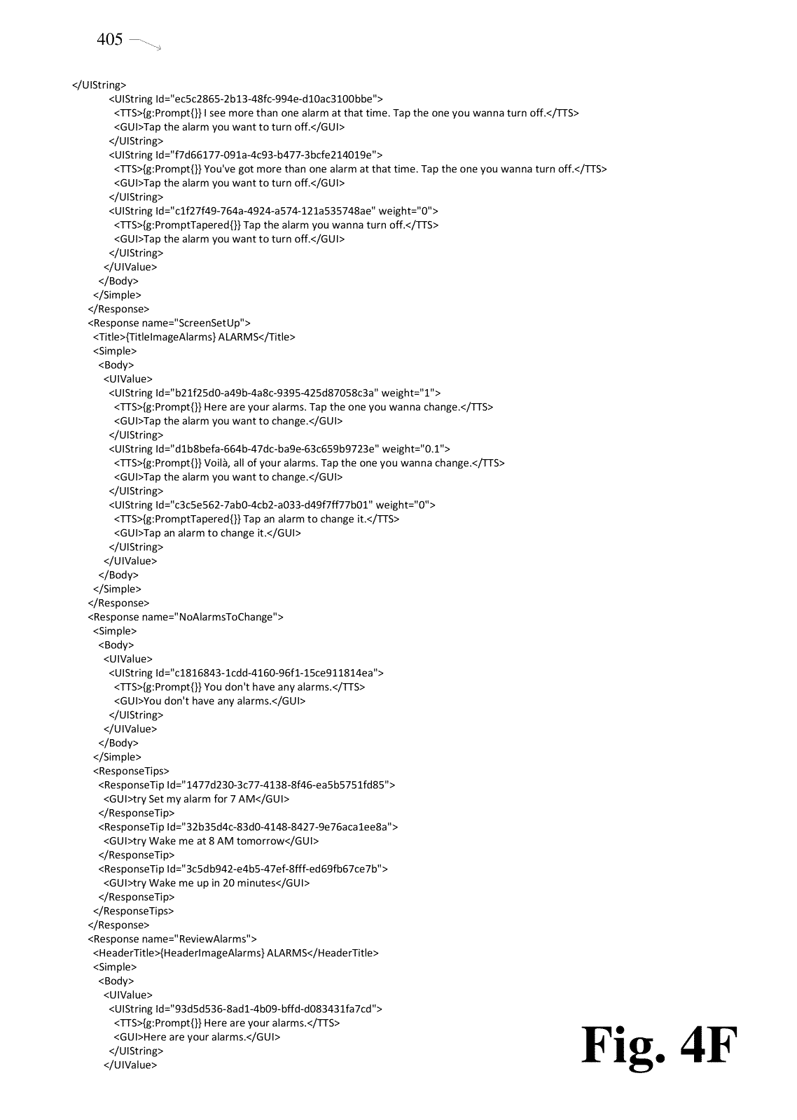

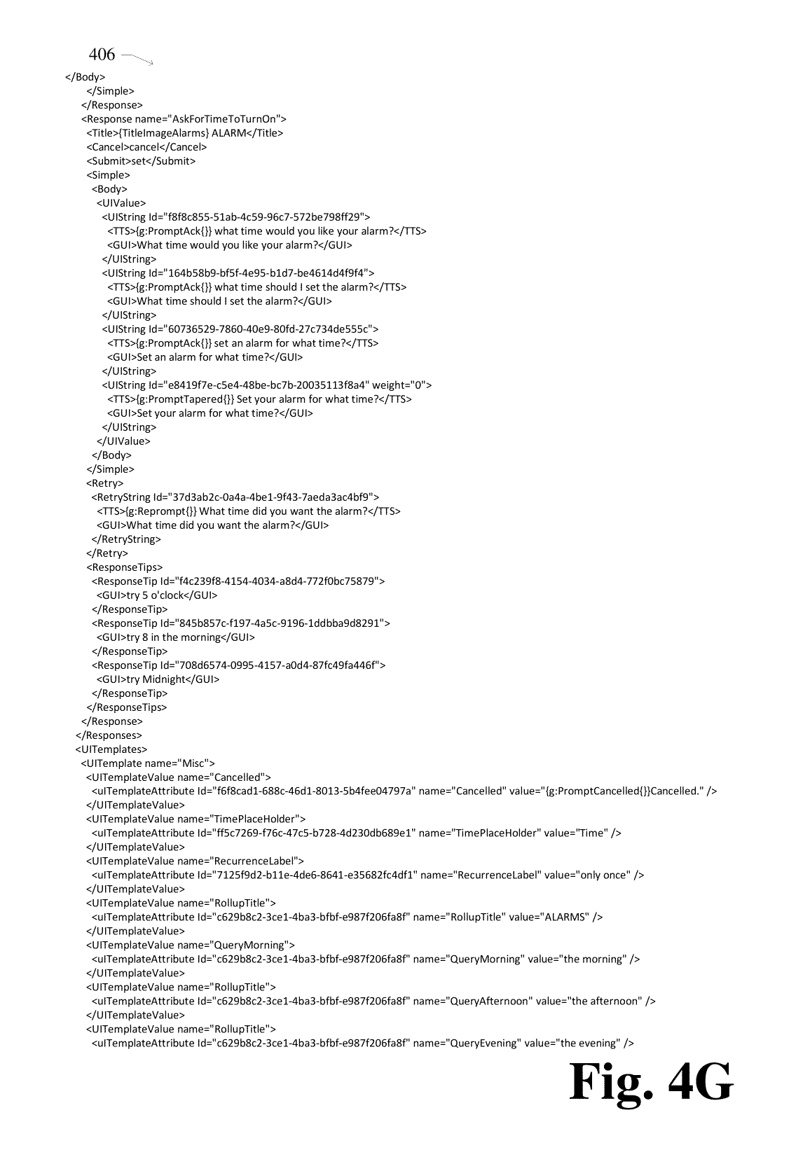

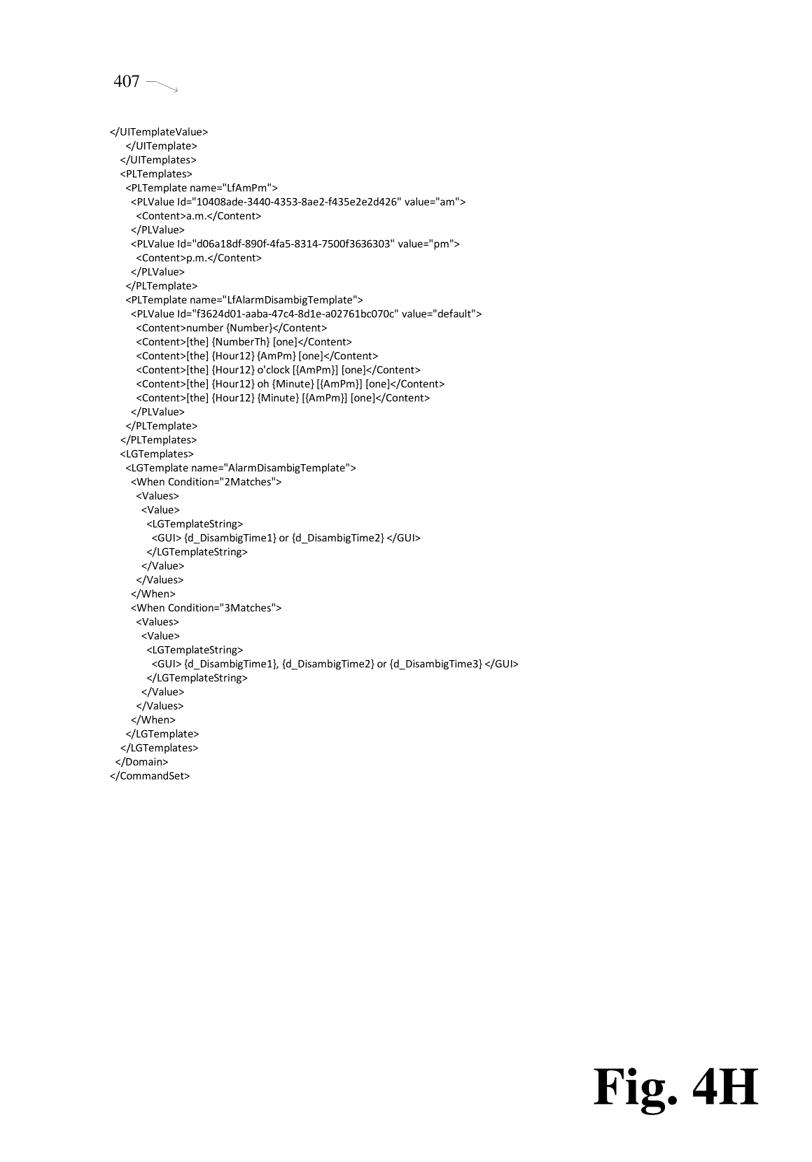

FIGS. 4A-4H illustrate an example XML schema used in a reactive agent definition, in accordance with an example embodiment of the disclosure. Referring to FIGS. 4A-4H, the XML schema 400-407 may be representative of the updated XML schema 128 for a RAD 126 for an “alarm” reactive agent.

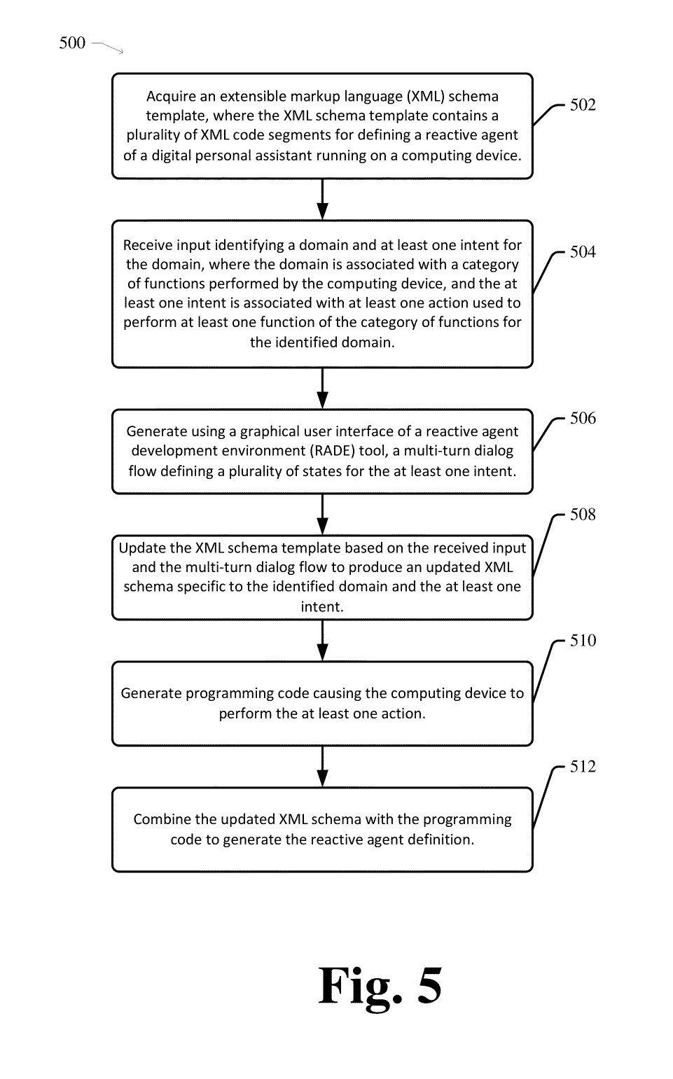

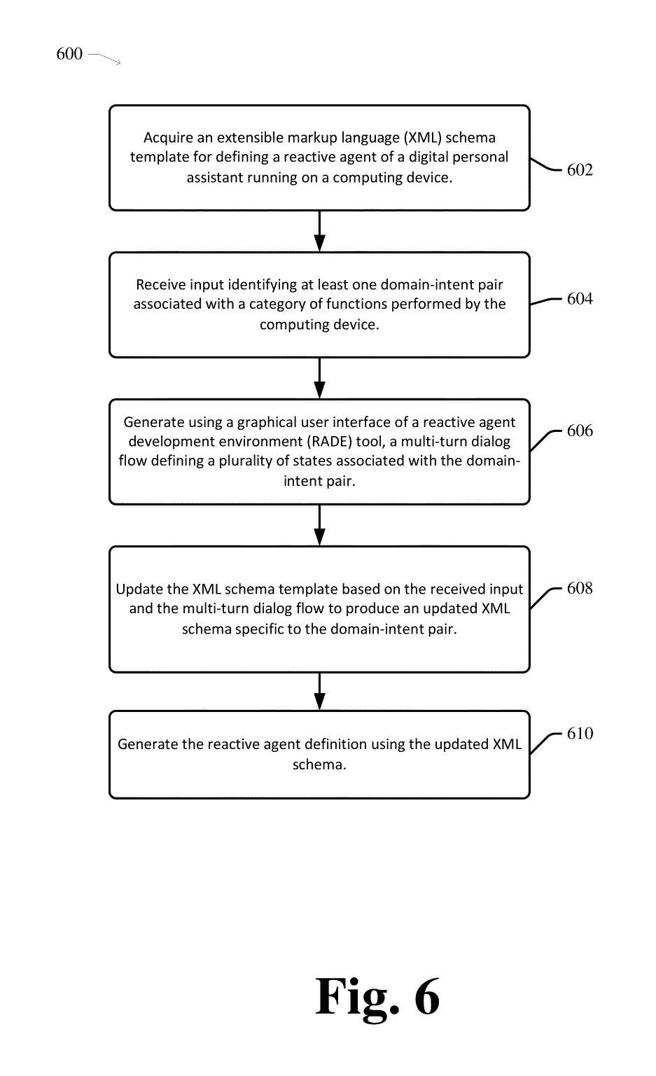

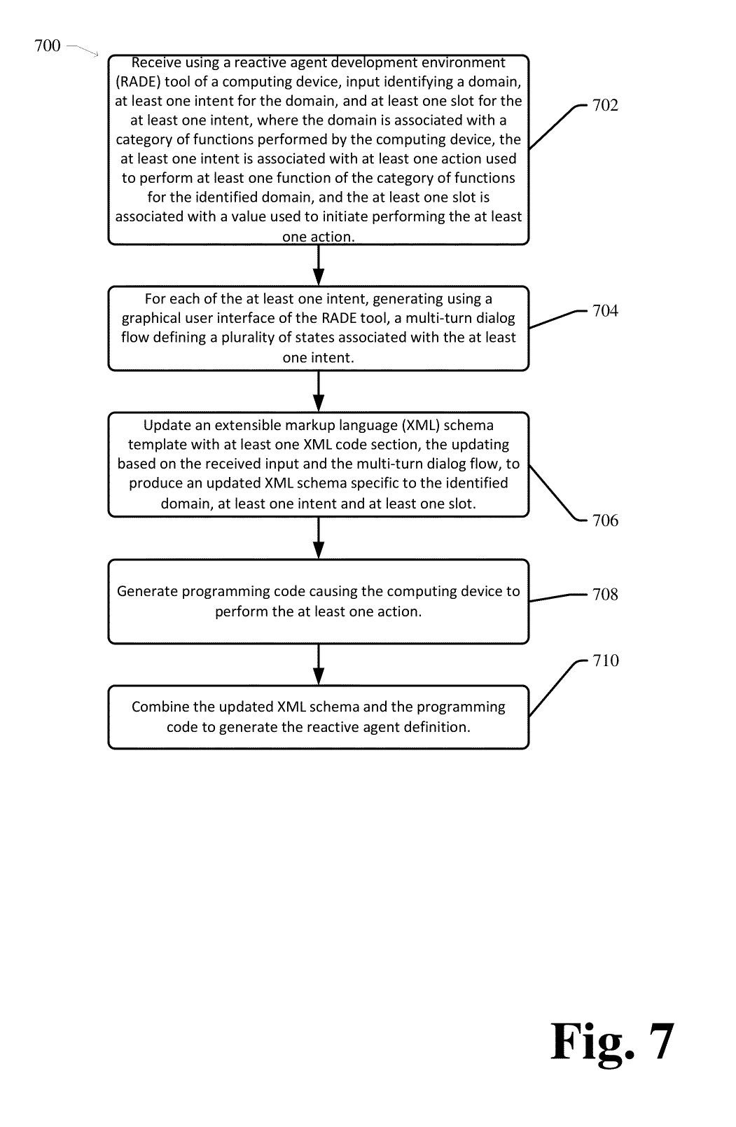

FIGS. 5-7 are flow diagrams illustrating generating of a reactive agent definition, in accordance with one or more embodiments. Referring to FIGS. 1-5, the example method 500 may start at 502, when the RADE tool 102 may acquire an extensible markup language (XML) schema template (e.g., 108). The XML schema template 108 may contains a plurality of XML code segments (e.g., 302-320) for defining a reactive agent of a digital personal assistant running on a computing device. At 504, the RADE tool 102 may receive input identifying a domain 120 and at least one intent 122 for the domain 120. The domain 120 may be associated with a category of functions performed by the computing device. The at least one intent 122 may be associated with at least one action used to perform at least one function of the category of functions for the identified domain 120. At 506, the RADE tool 102 may generate (e.g., using a graphical user interface 200 as seen in FIGS. 2A-2E), a multi-turn dialog flow (e.g., 220) defining a plurality of states for the at least one intent (e.g., set an alarm intent 210). At 508, the XML schema template 108 may be updated based on the received input and the multi-turn dialog flow to produce an updated XML schema (e.g., 128) specific to the identified domain (e.g., 120) and the at least one intent (e.g., 122). At 510, the RADE tool 102 may generate programming code (e.g., 130) causing the computing device to perform the at least one action (e.g., for an alarm reactive agent, the programming code segment 130 may be used to implement the setting of the alarm by the computing device). At 512, the RADE tool 102 may combine the updated XML schema 128 with the programming code segment 130 to generate the reactive agent definition 126.

Referring to FIGS. 1-4 and 6, the example method 600 may start at 602, when the RADE tool 102 may acquire an extensible markup language (XML) schema template (e.g., 108) for defining a reactive agent of a digital personal assistant running on a computing device. At 604, the RADE tool 102 may receive input (e.g., from a programming specification 118) identifying at least one domain-intent pair (e.g., 120-122) associated with a category of functions performed by the computing device. At 606, the RADE tool 102 may generate (e.g., using a graphical user interface 200 as seen in FIGS. 2A-2E) a multi-turn dialog flow (e.g., 220) defining a plurality of states associated with the domain-intent pair (e.g., set an alarm intent 210). At 608, the RADE tool 102 may update the XML schema template 108 based on the received input and the multi-turn dialog flow to produce an updated XML schema (e.g., 128) specific to the domain-intent pair (e.g., 120-122). At 610, the RADE tool 102 may generate the reactive agent definition (e.g., 126) using the updated XML schema (e.g., 128).

Referring to FIGS. 1-4 and 7, the example method 700 may start at 702, when the RADE tool 102 of a computing device (e.g., 800) may receive input identifying a domain (120), at least one intent (122) for the domain, and at least one slot (124) for the at least one intent. The domain is associated with a category of functions performed by the computing device (e.g., an alarm domain 202). The at least one intent (e.g., set an alarm intent 210) may be associated with at least one action used to perform at least one function of the category of functions for the identified domain. The at least one slot (e.g., alarm time slot 214) is associated with a value used to initiate performing the at least one action. At 704, for each of the at least one intent, the RADE tool may generate a multi-turn dialog flow (e.g., as seen in FIGS. 2A-2E) defining a plurality of states associated with the at least one intent. At 706, the RADE tool 102 may update an extensible markup language (XML) schema template (e.g., 108) with at least one XML code section (e.g., XML code sections 302-320 may be updated based on the generated multi-turn dialog flow for one or more intents 122 associated with a domain 120). The updating may be based on the received input (e.g., 120-124) and the multi-turn dialog flow (e.g., 202-222), to produce an updated XML schema (e.g., 128) specific to the identified domain (120), the at least one intent (122) and the at least one slot (124). At 708, the RADE tool 102 may generate programming code (e.g., 130) causing the computing device to perform the at least one action. At 710, the RADE tool may combine the updated XML schema (128) and the programming code (130) to generate the reactive agent definition (e.g., 126).

FIG. 8 is a block diagram illustrating an example mobile computing device in conjunction with which innovations described herein may be implemented. The mobile device 800 includes a variety of optional hardware and software components, shown generally at 802. In general, a component 802 in the mobile device can communicate with any other component of the device, although not all connections are shown, for ease of illustration. The mobile device 800 can be any of a variety of computing devices (e.g., cell phone, smartphone, handheld computer, laptop computer, notebook computer, tablet device, netbook, media player, Personal Digital Assistant (PDA), camera, video camera, etc.) and can allow wireless two-way communications with one or more mobile communications networks 804, such as a Wi-Fi, cellular, or satellite network.

The illustrated mobile device 800 includes a controller or processor 810 (e.g., signal processor, microprocessor, ASIC, or other control and processing logic circuitry) for performing such tasks as signal coding, data processing (including assigning weights and ranking data such as search results), input/output processing, power control, and/or other functions. An operating system 812 controls the allocation and usage of the components 802 and support for one or more application programs 811. The operating system 812 may include a reactive agent definition editing (RADE) tool 813, which may have functionalities that are similar to the functionalities of the sRADE tool 102 described in reference to FIGS. 1-7.

The illustrated mobile device 800 includes memory 820. Memory 820 can include non-removable memory 822 and/or removable memory 824. The non-removable memory 822 can include RAM, ROM, flash memory, a hard disk, or other well-known memory storage technologies. The removable memory 824 can include flash memory or a Subscriber Identity Module (SIM) card, which is well known in Global System for Mobile Communications (GSM) communication systems, or other well-known memory storage technologies, such as “smart cards.” The memory 820 can be used for storing data and/or code for running the operating system 812 and the applications 811. Example data can include web pages, text, images, sound files, video data, or other data sets to be sent to and/or received from one or more network servers or other devices via one or more wired or wireless networks. The memory 820 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 800 can support one or more input devices 830, such as a touch screen 832 (e.g., capable of capturing finger tap inputs, finger gesture inputs, or keystroke inputs for a virtual keyboard or keypad), microphone 834 (e.g., capable of capturing voice input), camera 836 (e.g., capable of capturing still pictures and/or video images), physical keyboard 838, buttons and/or trackball 840 and one or more output devices 850, such as a speaker 852 and a display 854. Other possible output devices (not shown) can include piezoelectric or other haptic output devices. Some devices can serve more than one input/output function. For example, touchscreen 832 and display 854 can be combined in a single input/output device. The mobile device 800 can provide one or more natural user interfaces (NUIs). For example, the operating system 812 or applications 811 can comprise multimedia processing software, such as audio/video player.

A wireless modem 860 can be coupled to one or more antennas (not shown) and can support two-way communications between the processor 810 and external devices, as is well understood in the art. The modem 860 is shown generically and can include, for example, a cellular modem for communicating at long range with the mobile communication network 804, a Bluetooth-compatible modem 864, or a Wi-Fi-compatible modem 862 for communicating at short range with an external Bluetooth-equipped device or a local wireless data network or router. The wireless modem 860 is typically configured for communication with one or more cellular networks, such as a GSM network for data and voice communications within a single cellular network, between cellular networks, or between the mobile device and a public switched telephone network (PSTN).

The mobile device can further include at least one input/output port 880, a power supply 882, a satellite navigation system receiver 884, such as a Global Positioning System (GPS) receiver, sensors 886 such as an accelerometer, a gyroscope, or an infrared proximity sensor for detecting the orientation and motion of device 800, and for receiving gesture commands as input, a transceiver 888 (for wirelessly transmitting analog or digital signals), and/or a physical connector 890, which can be a USB port, IEEE 1394 (FireWire) port, and/or RS-232 port. The illustrated components 802 are not required or all-inclusive, as any of the components shown can be deleted and other components can be added.

The mobile device can determine location data that indicates the location of the mobile device based upon information received through the satellite navigation system receiver 884 (e.g., GPS receiver). Alternatively, the mobile device can determine location data that indicates location of the mobile device in another way. For example, the location of the mobile device can be determined by triangulation between cell towers of a cellular network. Or, the location of the mobile device can be determined based upon the known locations of Wi-Fi routers in the vicinity of the mobile device. The location data can be updated every second or on some other basis, depending on implementation and/or user settings. Regardless of the source of location data, the mobile device can provide the location data to map navigation tool for use in map navigation.

As a client computing device, the mobile device 800 can send requests to a server computing device (e.g., a search server, a routing server, and so forth), and receive map images, distances, directions, other map data, search results (e.g., POIs based on a POI search within a designated search area), or other data in return from the server computing device.

The mobile device 800 can be part of an implementation environment in which various types of services (e.g., computing services) are provided by a computing “cloud.” For example, the cloud can comprise a collection of computing devices, which may be located centrally or distributed, that provide cloud-based services to various types of users and devices connected via a network such as the Internet. Some tasks (e.g., processing user input and presenting a user interface) can be performed on local computing devices (e.g., connected devices) while other tasks (e.g., storage of data to be used in subsequent processing, weighting of data and ranking of data) can be performed in the cloud.

Although FIG. 8 illustrates a mobile device 800, more generally, the innovations described herein can be implemented with devices having other screen capabilities and device form factors, such as a desktop computer, a television screen, or device connected to a television (e.g., a set-top box or gaming console). Services can be provided by the cloud through service providers or through other providers of online services. Additionally, since the technologies described herein may relate to audio streaming, a device screen may not be required or used (a display may be used in instances when audio/video content is being streamed to a multimedia endpoint device with video playback capabilities).

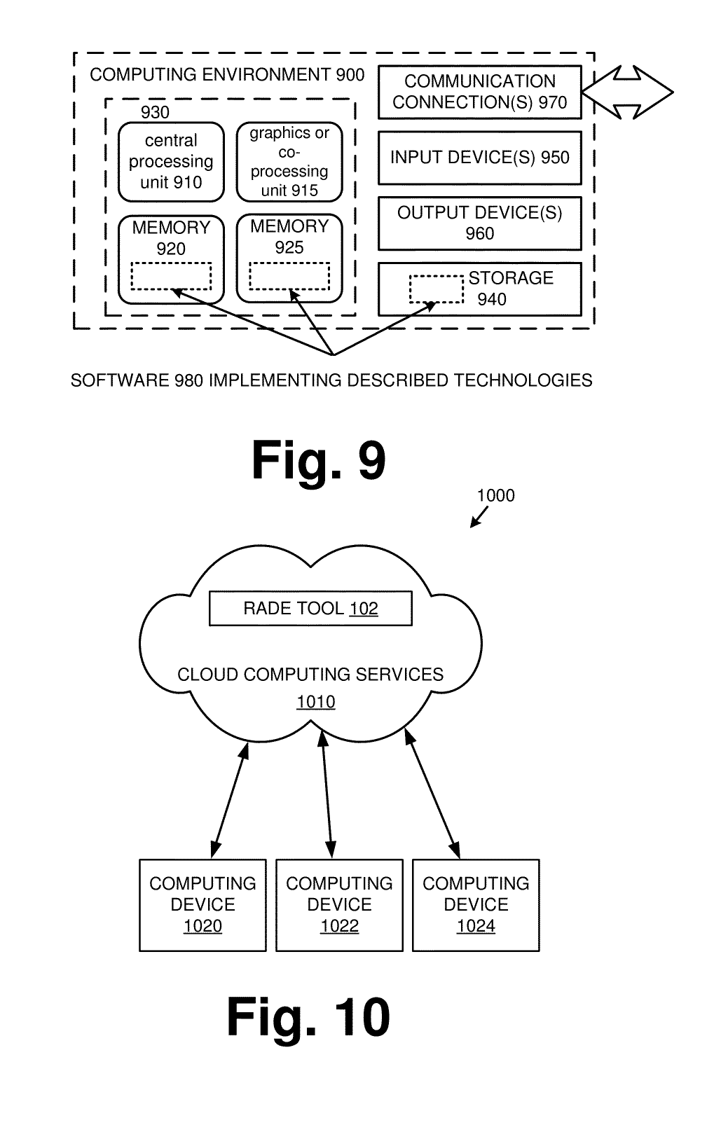

FIG. 9 is a diagram of an example computing system, in which some described embodiments can be implemented. The computing system 900 is not intended to suggest any limitation as to scope of use or functionality, as the innovations may be implemented in diverse general-purpose or special-purpose computing systems.

With reference to FIG. 9, the computing system 900 includes one or more processing units 910, 915 and memory 920, 925. In FIG. 9, this basic configuration 930 is included within a dashed line. The processing units 910, 915 execute computer-executable instructions. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 9 shows a central processing unit 910 as well as a graphics processing unit or co-processing unit 915. The tangible memory 920, 925 may be volatile memory (e.g., registers, cache, RAM), non-volatile memory (e.g., ROM, EEPROM, flash memory, etc.), or some combination of the two, accessible by the processing unit(s). The memory 920, 925 stores software 980 implementing one or more innovations described herein, in the form of computer-executable instructions suitable for execution by the processing unit(s).

A computing system may also have additional features. For example, the computing system 900 includes storage 940, one or more input devices 950, one or more output devices 960, and one or more communication connections 970. An interconnection mechanism (not shown) such as a bus, controller, or network interconnects the components of the computing system 900. Typically, operating system software (not shown) provides an operating environment for other software executing in the computing system 900, and coordinates activities of the components of the computing system 900.

The tangible storage 940 may be removable or non-removable, and includes magnetic disks, magnetic tapes or cassettes, CD-ROMs, DVDs, or any other medium which can be used to store information and which can be accessed within the computing system 900. The storage 940 stores instructions for the software 980 implementing one or more innovations described herein.

The input device(s) 950 may be a touch input device such as a keyboard, mouse, pen, or trackball, a voice input device, a scanning device, or another device that provides input to the computing system 900. For video encoding, the input device(s) 950 may be a camera, video card, TV tuner card, or similar device that accepts video input in analog or digital form, or a CD-ROM or CD-RW that reads video samples into the computing system 900. The output device(s) 960 may be a display, printer, speaker, CD-writer, or another device that provides output from the computing system 900.

The communication connection(s) 970 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

FIG. 10 is an example cloud computing environment that can be used in conjunction with the technologies described herein. The cloud computing environment 1000 comprises cloud computing services 1010. The cloud computing services 1010 can comprise various types of cloud computing resources, such as computer servers, data storage repositories, networking resources, etc. The cloud computing services 1010 can be centrally located (e.g., provided by a data center of a business or organization) or distributed (e.g., provided by various computing resources located at different locations, such as different data centers and/or located in different cities or countries). Additionally, the cloud computing service 1010 may implement the RADE tool 102 and other functionalities described herein relating to reactive agent definition generation and editing.

The cloud computing services 1010 are utilized by various types of computing devices (e.g., client computing devices), such as computing devices 1020, 1022, and 1024. For example, the computing devices (e.g., 1020, 1022, and 1024) can be computers (e.g., desktop or laptop computers), mobile devices (e.g., tablet computers or smart phones), or other types of computing devices. For example, the computing devices (e.g., 1020, 1022, and 1024) can utilize the cloud computing services 1010 to perform computing operations (e.g., data processing, data storage, reactive agent definition generation and editing, and the like).

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 9, computer-readable storage media include memory 920 and 925, and storage 940. The term “computer-readable storage media” does not include signals and carrier waves. In addition, the term “computer-readable storage media” does not include communication connections (e.g., 970).

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

1. A computing device, comprising:
a processing unit;
memory coupled to the processing unit;
one or more microphones;
one or more speakers;
at least one display;
the computing device configured with a reactive agent development environment (RADE) tool to perform operations for generating a reactive agent definition, the operations comprising:
acquiring an extensible markup language (XML) schema template, wherein the XML schema template contains a plurality of XML code segments for defining a reactive agent of a digital personal assistant running on the computing device, wherein the plurality of XML code segments designate:
at least one language generation template comprising metadata associated with one or more localization response strings, wherein the one or more localization response strings comprise response strings that are dynamically provided based on at least one data formatting rule that is geographic location-based;
receiving input identifying a domain and at least one intent for the domain, wherein:
the domain is associated with a category of functions performed by the computing device; and
the at least one intent is associated with at least one action used to perform at least one function of the category of functions for the identified domain;
generating using a graphical user interface of the RADE tool, a multi-turn dialog flow defining a plurality of states for the at least one intent;
updating the XML schema template based on the received input and the multi-turn dialog flow to produce an updated XML schema specific to the identified domain and the at least one intent;
generating programming code causing the computing device to perform the at least one action; and
combining the updated XML schema with the programming code to generate the reactive agent definition.

2. The computing device according to claim 1, wherein the plurality of XML code segments further designate at least one of:
the plurality of states for the at least one intent;
one or more transitions between at least two of the plurality of states; and
at least one user interface response template comprising metadata associated with one or more response strings provided by the digital personal assistant.

3. (canceled)

4. The computing device according to claim 1, the operations further comprising:
generating using the graphical user interface of the RADE tool, a phrase list template comprising one or more expected user input phrases for providing input to the digital personal assistant.

5. The computing device according to claim 4, wherein updating the XML schema template further comprises:
embedding the phrase list template as part of the at least one language generation template.

6. The computing device according to claim 1, the operations further comprising:
receiving input identifying at least one slot associated with the domain and the at least one intent, the at least one slot indicating a value used for performing the at least one action.

7. The computing device according to claim 6, the operations further comprising:
generating using the RADE tool, an association between the at least one slot and the at least one intent.

8. The computing device according to claim 1, the operations further comprising:
generating the multi-turn dialog flow using a plurality of editing tools associated with the graphical user interface of the RADE tool.

9. The computing device according to claim 9, wherein the editing tools comprise:
a plurality of dialog flow tools for defining the multi-turn dialog flow; and
a plurality of intent tools for defining the at least one intent and the plurality of states associated with the multi-turn dialog flow.

10. The computing device according to claim 1, wherein the XML schema template is a data structure comprising:
information that represents a domain selection;
information that represents an intent selection associated with the domain selection;
information that represents a state selection associated with the intent selection; and
information that represents a slot selection associated with the domain selection and the intent selection.

11. A method, implemented by a computing device comprising a reactive agent definition editing (RADE) tool, for generating a reactive agent definition, the method comprising:
acquiring an extensible markup language (XML) schema template for defining a reactive agent of a digital personal assistant running on the computing device, wherein the XML schema template comprises:
at least one language generation template comprising metadata associated with one or more localization response strings, wherein the one or more localization response strings comprise response strings that are dynamically provided based on at least one data formatting rule that is geographic location-based;
receiving input identifying at least one domain-intent pair associated with a category of functions performed by the computing device;
generating using a graphical user interface of the RADE tool, a multi-turn dialog flow defining a plurality of states associated with the domain-intent pair;
updating the XML schema template based on the received input and the multi-turn dialog flow to produce an updated XML schema specific to the domain-intent pair; and
generating the reactive agent definition using the updated XML schema.

12. The method according to claim 11, wherein the domain-intent pair comprises:
domain information identifying a domain associated with a category of functions performed by the computing device; and
intent information identifying an intent associated with at least one action used to perform at least one function of the category of functions.

13. The method according to claim 12, further comprising:
receiving input identifying at least one slot associated with the domain-intent pair, the at least one slot indicating a value used for performing the at least one action.

14. The method according to claim 13, further comprising:
generating using the RADE tool, an association between the at least one slot and the intent.

15. The method according to claim 14, wherein updating the XML schema template comprises:
generating at least one XML code segment representative of the association between the at least one slot and the intent.

16. The method according to claim 11, further comprising:
annotating at least one of a plurality of XML code sections within the updated XML schema with at least one annotation indicative of an XML code type.

17. The method according to claim 12, further comprising:
generating programming code causing the computing device to perform the at least one action; and
combining the updated XML schema with the programming code to generate the reactive agent definition.

18. A computer-readable storage medium storing computer-executable instructions for causing a computing device to perform operations for generating a reactive agent definition of a digital personal assistant running on the computing device, the operations comprising:
receiving using a reactive agent definition editing (RADE) tool of the computing device, input identifying a domain, at least one intent for the domain, and at least one slot for the at least one intent, wherein:
the domain is associated with a category of functions performed by the computing device;
the at least one intent is associated with at least one action used to perform at least one function of the category of functions for the identified domain; and
the at least one slot is associated with a value used to initiate performing the at least one action;
for each of the at least one intent, generating using a graphical user interface of the RADE tool, a multi-turn dialog flow defining a plurality of states associated with the at least one intent;
updating using the RADE tool, an extensible markup language (XML) schema template with at least one XML code section, the updating based on the received input and the multi-turn dialog flow, to produce an updated XML schema specific to the identified domain, the at least one intent and the at least one slot, wherein the XML schema template comprises:
at least one language generation template comprising metadata associated with one or more localization response strings, wherein the one or more localization response strings comprise response strings that are dynamically provided based on at least one data formatting rule that is geographic location-based;
generating programming code causing the computing device to perform the at least one action; and
combining the updated XML schema and the programming code to generate the reactive agent definition.

19. The computer-readable storage medium according to claim 18, the operations further comprising acquiring the XML schema template for defining the reactive agent, wherein the XML schema template is a data structure, the data structure comprising:
information that represents a domain selection;
information that represents an intent selection associated with the domain selection;
information that represents a state selection associated with the intent selection; and
information that represents a slot selection associated with the domain selection and the intent selection.

20. The computer-readable storage medium according to claim 18, the operations further comprising:
generating at least one response string based on the multi-turn dialog flow; and
updating the XML schema template based on the generated response string.

21. The computing device according to claim 1, wherein the XML schema template comprises:
a plurality of example phrases that, when spoken by a user, will activate a specific dialog state associated with the plurality of example phrases.
